(19) United States
(12) Patent Application Publication
(10) Pub. No.: US 2003/0165305 A1
(43) Pub. Date: Sep. 4, 2003

(54) Adhesive for bonding an optoelectronic device

(76) Inventors: Joseph L. Dallas, Maple Glen, PA (US); Angelique X. Irvin, Radnor, PA (US); Robert W. Irvin, Radnor, PA (US); Ralph S. Jameson, Orefield, PA (US); William A. Mamakos, Laurel, MD (US)

Correspondence Address: CANTOR COLBURN, LLP, 55 GRIFFIN ROAD SOUTH, BLOOMFIELD, CT, 06002

(21) Appl. No.: 10/091,055

(22) Filed: Mar. 4, 2002

(51) Int. Cl. G02B 6/42; C09J 4/00

(52) U.S. Cl. 385/92; 156/325

(57) ABSTRACT

An adhesive for bonding an optoelectronic device within a hermetically sealable package comprising a low outgassing adhesive selected to limit the outgassing of organic molecules in a cured state.

### BACKGROUND

The present invention relates to optoelectronic assemblies, and more particularly, to an adhesive for bonding an optoelectronic device in hermetically sealable packages.

In recent years, there have been proposed optical interconnecting methods, in which a plurality of optical fiber lines are used to connect apparatuses such as large computers or mass-storage information exchange systems. These optical interconnecting methods generally involve connecting apparatuses using an optical fiber line which is made of a plurality of optical fibers and transmitting optical signals in parallel.

The plurality of optical fibers generally includes a fiber optic ribbon assembly terminating in a fiber optic array, which in turn is optically aligned with a communicating integrated optics device. The integrated optics device can also include electronic or optoelectronic components (e.g., an laser diode (LD) array or a photodiode (PD) array fixed in a package). Each optical fiber acts as a conduit for light onto and off the integrated optics device. The fiber optic array is supported within the package by an entry ferrule or support plate and is optically aligned with the integrated optics device. The package includes a casing or housing which has a part holding the integrated optics device and an entry part within which the fiber optic array is supported at a support location using the ferrule or support plate. The design of reliable optoelectronics devices requires that the spectral ends of the fiber array within a hermetically sealed package do not experience degradation due to the ingress of ambient air or moisture. Furthermore, the design of reliable optoelectronics devices within a hermetically sealed package requires that they not experience degradation due to moisture and air within the sealed package and are suitably bonded within the package to maintain the integrity of the sensitive optical surfaces inside such packages (e.g., the spectral ends of the fiber array).

A conventional sealed fiber array for an optical transmission module is disclosed, for example, in JP-A-8-179171. In such a sealed fiber array, optical fibers are arranged in respective V grooves, and both ends of the fiber array are polished optically. The end of the fiber array to be exposed to outside of a package of the transmission module is capable of being connected to an optical connector.

Contaminants within a package can directly affect device performance, and/or cause degradation of device components over time, which also affects device performance. Device performance may also be affected if bonds within the package cause the sensitive optical surface to become misaligned. Consequently, there remains a need for methods of decreasing or eliminating degradation of optical components in a hermetically sealed package, while suitably bonding optoelectronic devices therein and limiting the problems of distortion appearing in micro order due to degradation of the hermetic seal, degradation of the optical ruminating surfaces due to ambient air and dew within the hermetically sealed package.

### BRIEF SUMMARY

There is provided an adhesive for bonding an optoelectronic device within a hermetically sealable package comprising a low outgassing adhesive selected to limit the outgassing of organic molecules in a cured state.

### BRIEF DESCRIPTION OF THE DRAWINGS

This disclosure will present in detail the following description of preferred embodiments with reference to the exemplary drawings wherein like elements are numbered alike in the several FIGURES:

FIG. 1 is an exploded, perspective view illustrating an array of multiple optical fibers for disposal in a package housing;

FIG. 2 is a perspective view illustrating the multi-fiber array of FIG. 1 hermetically sealed in an aperture formed in the package housing; and

FIG. 3 is a sectional view of a hermetically sealed package illustrating various optoelectronic devices bonded therein.

### DETAILED DESCRIPTION OF THE PREFERRED EMBODIMENTS

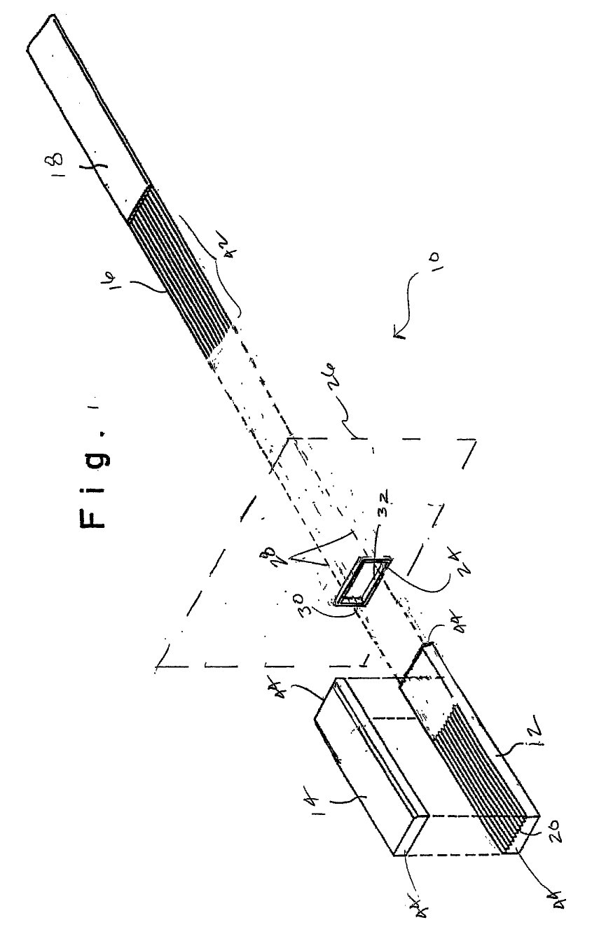

Some embodiments of the invention will now be described in detail in the following examples. An optical fiber array 10 is shown in FIG. 1. The optical fiber array 10 comprises a lower substrate 12 and an upper substrate 14 which are made of silicon wafers, and a plurality of optical fibers 16 are disposed between the lower substrate 12 and the upper substrate 14. The optical fibers 16 extend from a ribbon part (coated region) 18 of a multi-optical fiber ribbon. The lower substrate 12 has a plurality of V-shaped grooves 20 for storing the optical fibers 16 in position, and every optical fiber 16 to be placed in each V-shaped groove 20 is maintained inside each V-shaped groove 20 by upper substrate 14.

Optical fiber array 10 is shown in an exploded view in relation to being fitted in an aperture 24 defined in a package housing 26 of a package for an integrated optics device (not shown). It is preferred that at least the lower substrate 12 has V-shaped grooves 20 formed therein, although both substrates may have grooves formed therein and aligned with a complementary groove on the other substrate. The fibers 16 are disposed in corresponding V-shaped grooves 20 of lower substrate 12 and upper substrate 14 is aligned and pressed down to passively align fibers 16 in a respective groove 20.

Optical fibers 16 are further maintained inside each V-shaped groove 20 using an adhesive (not shown, but discussed more fully herein) that bonds the fibers 16 and upper substrate 14 to lower substrate 12. The adhesive preferably forms a hermetic seal between each fiber 16 and between lower and upper substrates 12, 14 to limit degradation of the optical fiber array 10 and the optics device in optical communication with the spectural ends of the fiber array disposed within the package due to ingress of ambient air. Aperture 24 is configured in package housing 26 to allow assembled optical fiber array 10 to be disposed therein as depicted with phantom lines 28. Aperture 24 is defined by edges 32 formed in package housing 26 to allow entry of lower and upper substrates 12, 14 having hermetically sealed fibers 16. A gap 30 is defined between edges 32 and periphery portions of lower substrate 12 and upper substrate 14 when assembled optical fiber array 10 is disposed in aperture 24. It is desired to form a hermetic seal between the assembled optical array 10 and edges 32 defining aperture 24 in package housing 26 to provide a hermetically sealed optoelectronic package which is discussed more fully herein. The resulting fiber array 10 is disposed in aperture 24 of package housing 26 using active or passive alignment means known in the pertinent art to obtain optical alignment with an opponent member disposed in the package.

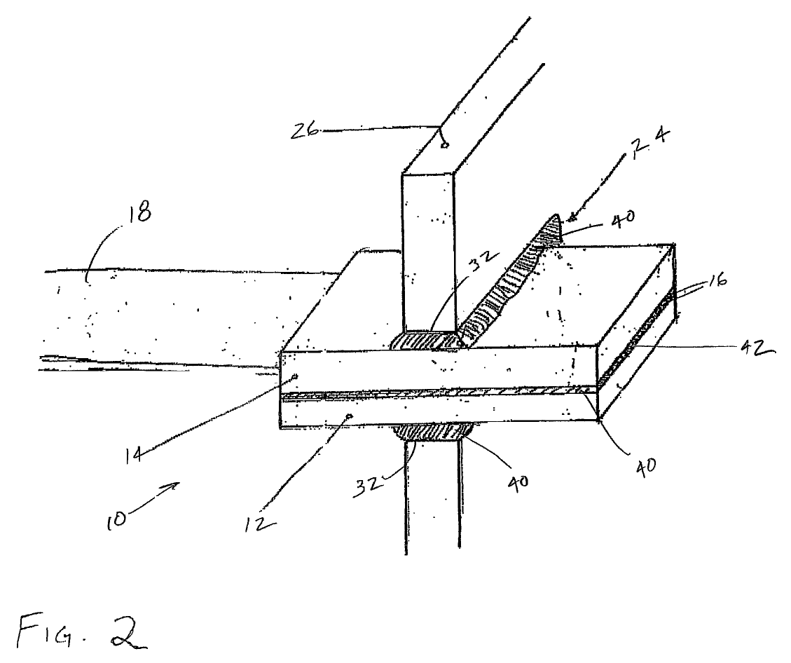

Referring to FIG. 2, the optical fiber array 10 shown in FIG. 1 is shown assembled and disposed in package housing 26 via aperture 24. Optical fiber array 10 forms a hermetic seal in aperture 24 formed in package housing 26 by bonding optical fiber array 10 within aperture 24 using an adhesive 40 in gap 30. Adhesive 40 is also used for bonding fibers 16 in V-grooves 20 and for bonding lower and upper substrates 12, 14 to form the hermetically sealed fiber array 10. After disposing fiber array 10 in aperture 24, gap 30 is filled with adhesive agent 40 described below to form an air-tight seal between fiber array 10 and edges 32 defining aperture 24 in package housing 26.

Adhesive 40 is preferably low outgassing in a cured state to effectively limit outgassing of organic molecules that can cause degradation of the fiber array 10, spectral ends 42 of fibers 16, and any opponent member in optical communication with fiber array 10 in a hermetically sealed package (not shown). One method for measuring outgassing is set forth in ASTM E595, in which the percent weight loss of a sample held at 125° C. for 24 hours is measured. Low outgassing adhesives are those wherein the percent weight loss of a sample as measured by ASTM E595 is less than about 1%, more preferably less than about 0.5% and most preferably less than about 0.1%. As used herein, low outgassing adhesives include those sometimes referred to as “low VOC”. Suitable low outgassing adhesives accordingly have low (0.5% or less by weight) levels of volatile organic compounds, i.e., less than or equal to about 0.5% by weight of compounds capable of being driven off as a vapor at room temperature or slightly elevated temperatures, e.g., up to about 120° F. (48.9° C.).

A number of low outgassing thermosetting adhesives are known in the art, including for example various epoxy adhesives, fluorinated ethylene propylene adhesives, acrylic adhesives, and polyester adhesives. Epoxy adhesives are preferred, such adhesives also being referred to in the art as polyepoxide, epoxide or epoxy resin adhesives. Epoxy adhesives comprise at least one component that has an aliphatic, cycloaliphatic, or aromatic backbone containing more than one alpha-oxirane group capable of being polymerized. The adhesive compositions may further comprise a monofunctional epoxy resin in the amount of not more than about 30% by weight, preferably not more than about 20% by weight based on the total weight of the epoxy resins. Details of applicable epoxy resin systems are set forth in the available literature, for example in a textbook entitled “Handbook of Epoxy Resins”, by H. Lee et al, McGraw-Hill, 1967, which is incorporated herein by reference.

Examples of suitable polyfunctional epoxy resin include bisphenol A epoxy resins, bisphenol F epoxy resins, phenol novolac epoxy resins, cresol novolac epoxy resins, and the like. Two or more kinds of these epoxy resins may be used in combination. Preferably the epoxy resin is low outgassing.

Bisphenol epoxy resins are preferred, and bisphenol A epoxy resins are more preferably used, particularly the diglycidyl ether of bisphenol A. Bisphenol A epoxy resins are commercially available, for example under the trade names Epikote 825 and Epikote 828 (manufactured by Yuka Shell Co.); Araldite 250, Araldite 2500, Araldite 260 and Araldite 2600 (manufactured by Asahi Ciba Co.); DER 331J, DER 331P, DER 331L and DER 332 (manufactured by Dow Chemical Co.); YD 128 (manufactured by Toto Kasei Co.); and RE310 and RE410 (manufactured by Nippon Kayaku Co.).

The epoxy adhesive may be cured by heat, radiation (e.g., ultraviolet light) in the presence of a heat or a radiation activated catalyst, or by admixture with a curing agent. Preferably, the catalysts and/or curing agents are themselves low outgassing. Suitable curing agents are known, including but not limited to primary, secondary, or tertiary amines and polyamines (diethylene diamine for example), substituted ureas, carboxylic acids, anhydrides, phenols, polyamides, formaldehyde resins, polycarboxylic acid polyesters, Lewis acids and bases, polysulfides, polymercaptans, and phenol novolac resins. In general, these types of epoxy adhesives are provided as two-part systems, one part containing the epoxy resin and another part containing the cure agent. Combinations of different modes of curing may also be used.

Exemplary low outgassing adhesives are commercially available, and include, for example a two-part epoxy adhesive with outgassing less than 1000 μg/g as measured at 85° C. for 3 hours with the tradename Scotch-Weld DP-460 EG commercially available from 3M; a two component, room temperature cure epoxy with outgassing less than 0.19% with the tradename ECE-101 commercially available from appli-tec inc.; a two part, room temperature cure epoxy with the tradename EP65HT-1 commercially available from Master Bond; a UV gellable, low temperature cure, one component epoxy adhesive with the tradename EN 139-2 commercially available from Resin Technology Group, LLC; and a low viscosity, room temperature cure epoxy with outgassing less than 19.4 ppm at 105° C. with the tradename BONDLINE 655 commercially available from Bondline Electronic Adhesives, Inc.

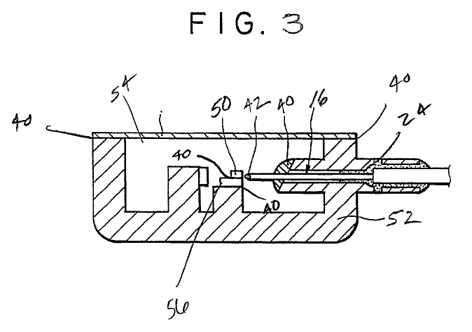

A conventional light-emitting module using a single lensed optical fiber 16 has an arrangement shown in FIG. 3, for example, as disclosed in Unexamined Japanese Utility Model Publication (KOKAI) No. 3-6612. As illustrated, a bare laser diode (LD) 50 is bonded within a package 52 having an upper open end 54. LD 50 is bonded to a substrate 56, which in turn, is bonded to package 52 using adhesive 40. A lensed optical fiber 16 is inserted through aperture 24 in a wall or housing of the package 52 in such a manner that lens 42 at the fiber end faces the light-emitting surface of the LD 50 with a space of about 10 μm therebetween. To protect the LD 50 against oxidation and moisture, a cover 4 is fitted and bonded with adhesive 40 on the open end 54 of the package 52, and the lensed optical fiber 16 is firmly secured to the wall by adhesive 40, so that the package 52 has an airtight structure. It will be appreciated that although LD 50 is described as being bonded to substrate 56 with package 52, LD 50 is optionally any optoelectronic device such as an optical fiber, waveguide, fiber array, or other optical diode bonded to a substrate with adhesive 40 within package 52. Optical diodes include, but are not limited to LD's, light emitting diodes (LED's), photodetectors (PD's), and the like. It will be also understood that the above optoelectronic devices are optionally bonded to package 52 without use an intermediary substrate 56.

Recently, there is an increasing demand for a light-emitting module capable of connecting an LD array, which includes a plurality of LDs (light sources), to an optical fiber array 10, which includes a plurality of optical fibers 16 arranged in a fiber array block described above, by means of a lens array including a plurality of lenses, thereby collectively coupling the LDs to the respective optical fibers within a hermetically sealable package. It will be appreciated that the methods described with reference to FIGS. 1-3 provide a method using adhesive 40 of optically connecting an LD array with a fiber array 10 in a hermetically sealed package.

In a method of manufacturing a sealed fiber array with a package housing according to the present disclosure, the desired epoxy combines the non-outgassing properties of glass and solder bonding, with the desirable properties of organic adhesives, e.g., having a low viscosity at room temperature, undergoing a chemical reaction to solidify the material, and providing a high bond strength. The method provides an optical fiber array fixed within a package entirely sealed with high airtightness, and a lens or an optical device provided in the package that is sufficiently protected. According to the embodiments described above, to prevent ambient air is from entering through the gap formed by disposing fiber array 10 in aperture 24 toward the side opposite thereto, a sealing function can be obtained by forming a hermetic seal fixing array 10 in aperture 24 using low outgassing adhesive 40, so that the elements in the package may not degrade due to the ambient air entering through the gap between the fiber array and edges defining the aperture in the package wall to support the fiber array in the package. Moreover, the low outgassing adhesive effectively limits the outgassing of organic molecules within the hermetically sealed package when the adhesive is in a nominal or fully cured state, thus reducing the degradation of optoelectronic devices within the package.

In bonding an optoelectronic device within a package, epoxies provide many advantages including low cure temperatures, room temperature working conditions, optical transmission, flow to fill bond gaps, etc. However, a key limitation in their use has been the outgassing of organic molecules after the epoxy is (nominally) fully cured. Such outgassing can result in the production of small organic molecules, volatile organic compounds (VOCs), corrosive vapors, moisture, or the like. Materials exist that are used to make non-outgassing bonds, although these materials are not considered adhesives per se, e.g., solders and low melting temperature glasses (solder-glass). The present disclosure provides a low outgassing adhesive that limits the deposition of organic molecules on sensitive optical surfaces inside a hermetically sealable package.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An adhesive for bonding an optoelectronic device within a hermetically sealable package comprising:
a low outgassing adhesive selected to limit the outgassing of organic molecules in a cured state.

2. The adhesive according to claim 1, wherein said low outgassing adhesive includes low volatile organic compounds (VOC), said low VOC have a percent weight loss of less than about 0.5% at a temperature of up to about 120° F. (48.9° C.).

3. The adhesive according to claim 1, wherein said low outgassing adhesive includes a thermosetting adhesive.

4. The adhesive according to claim 3, wherein said thermosetting adhesive is selected from one of epoxy adhesives, fluorinated ethylene propylene adhesives, acrylic adhesives, and polyester adhesives.

5. The adhesive according to claim 4, wherein said epoxy adhesives further comprise at least one component having one of an aliphatic, a cycloaliphatic, and an aromatic backbone containing more than one alpha-oxirane group capable of being polymerized.

6. The adhesive according to claim 5, wherein said adhesive compositions further comprise an epoxy resin.

7. The adhesive according to claim 6, wherein said adhesive compositions may further comprise a monofunctional epoxy resin in the amount of not more than about 30% by a weight based on a total weight of said epoxy resin.

8. The adhesive according to claim 6, wherein said adhesive compositions may further comprise a monofunctional epoxy resin in the amount of not more than about 20% by weight based on said total weight of said epoxy resin.

9. The adhesive according to claim 5, wherein said adhesive compositions may further comprise a polyfunctional epoxy resin, said polyfunctional epoxy resin including one of bisphenol A epoxy resins, bisphenol F epoxy resins, phenol novolac epoxy resins, cresol novolac epoxy resins, and combinations including at least one of the forgoing.

10. The adhesive according to claim 9, wherein said bisphenol A epoxy resins include diglycidyl ether.

11. The adhesive according to claim 4, wherein said epoxy adhesive includes an epoxy resin and a curing agent curable with radiation.

12. The adhesive according to claim 11, wherein said curing agent includes one of primary, secondary, or tertiary amines and polyamines, substituted ureas, carboxylic acids, anhydrides, phenols, polyamides, formaldehyde resins, polycarboxylic acid polyesters, Lewis acids and bases, polysulfides, polymercaptans, phenol novolac resin, and combinations including at least one of the forgoing.

13. The adhesive according to claim 11 wherein said radiation includes one of heat and ultraviolet light.

14. The adhesive according to claim 1 wherein said adhesive bonds the optoelectronic device to a substrate.

15. The adhesive according to claim 1 wherein said adhesive bonds a cover to the hermetically sealable package, forming an air tight package.

16. The adhesive according to claim 1 wherein the optoelectronic device includes one of an optical fiber, an optical fiber array, a waveguide, and an optical diode.

17. An adhesive for bonding an optoelectronic device within a hermetically sealable package comprising:
a low outgassing adhesive selected to limit the outgassing of organic molecules in a cured state, wherein said low outgassing adhesive includes low volatile organic compounds (VOC), said low VOC have a percent weight loss of less than about 0.5% at a temperature of up to about 120° F. (48.9° C.).

18. A hermetically sealable package having an optoelectronic device bonded therein comprising:
a housing configured to form a hermetic seal therein;
an optoelectronic device disposed within said package; and
a low outgassing adhesive bonding said optoelectronic device within said package, said low outgassing adhesive selected to limit the outgassing of organic molecules in a cured state in said hermetically sealable package.

19. The package according to claim 18, wherein said low outgassing adhesive includes low volatile organic compounds (VOC), said low VOC have a percent weight loss of less than about 0.5% at a temperature of up to about 120° F. (48.9° C.).

20. The package according to claim 18, wherein said low outgassing adhesive includes a thermosetting adhesive.

21. The package according to claim 20, wherein said thermosetting adhesive is selected from one of epoxy adhesives, fluorinated ethylene propylene adhesives, acrylic adhesives, and polyester adhesives.

22. The package according to claim 21, wherein said epoxy adhesives further comprise at least one component having one of an aliphatic, a cycloaliphatic, and an aromatic backbone containing more than one alpha-oxirane group capable of being polymerized.

23. The package according to claim 22, wherein said adhesive compositions further comprise an epoxy resin.

24. The package according to claim 23, wherein said adhesive compositions may further comprise a monofunctional epoxy resin in the amount of not more than about 30% by a weight based on a total weight of said epoxy resin.

25. The package according to claim 24, wherein said adhesive compositions may further comprise a monofunctional epoxy resin in the amount of not more than about 20% by weight based on said total weight of said epoxy resin.

26. The package according to claim 22, wherein said adhesive compositions may further comprise a polyfunctional epoxy resin, said polyfunctional epoxy resin including one of bisphenol A epoxy resins, bisphenol F epoxy resins, phenol novolac epoxy resins, cresol novolac epoxy resins, and combinations including at least one of the forgoing.

27. The package according to claim 26, wherein said bisphenol A epoxy resins include diglycidyl ether.

28. The package according to claim 21, wherein said epoxy adhesive includes an epoxy resin and a curing agent curable with radiation.

29. The package according to claim 28, wherein said curing agent includes one of primary, secondary, or tertiary amines and polyamines, substituted ureas, carboxylic acids, anhydrides, phenols, polyamides, formaldehyde resins, polycarboxylic acid polyesters, Lewis acids and bases, polysulfides, polymercaptans, phenol novolac resin, and combinations including at least one of the forgoing.

30. The package according to claim 28 wherein said radiation includes one of heat and ultraviolet light.

31. The adhesive according to claim 18, wherein said adhesive bonds the optoelectronic device to a substrate.

32. The adhesive according to claim 18, wherein said housing includes a cover and package wall, said adhesive bonds said cover to said package wall forming an air tight package.

33. The adhesive according to claim 18, wherein the optoelectronic device includes one of an optical fiber, an optical fiber array, a waveguide, and an optical diode.
